(19) United States
(12) Patent Application Publication
(10) Pub. No.: US 2025/0247259 A1
(43) Pub. Date: Jul. 31, 2025

(54) CONSENSUS METHOD AND APPARATUS FOR BLOCKCHAIN, COMPUTER-READABLE MEDIUM, AND ELECTRONIC DEVICE

(71) Applicant: TENCENT TECHNOLOGY (SHENZHEN) COMPANY LIMITED, Shenzhen (CN)

(72) Inventor: Neng WANG, Shenzhen (CN)

(21) Appl. No.: 19/184,951

(22) Filed: Apr. 21, 2025

Related U.S. Application Data
(63) Continuation of application No. PCT/CN2023/130671, filed on Nov. 9, 2023.

(30) Foreign Application Priority Data
Apr. 7, 2023 (CN) 202310407004.0

(51) Int. Cl. H04L 9/00

(52) U.S. Cl. CPC H04L 9/50

(57) ABSTRACT

A consensus method for a blockchain includes: obtaining, based on recorded proposal waiting parameters corresponding to blockchain nodes, a proposal waiting parameter corresponding to a current proposal node in the blockchain nodes; determining, based on the proposal waiting parameter corresponding to the current proposal node, proposal waiting duration corresponding to the current proposal node; and adjusting, in response to a proposal message initiated by the current proposal node is not received within the proposal waiting duration at a proposal stage of the current proposal node, the proposal waiting parameter corresponding to the current proposal node to reduce the proposal waiting duration corresponding to the current proposal node.

### CROSS-REFERENCES TO RELATED APPLICATIONS

This application is a continuation of PCT Application No. PCT/CN2023/130671, filed on Nov. 9, 2023, which claims priority to Chinese Patent Application No. 202310407004.0, filed with the China National Intellectual Property Administration on Apr. 7, 2023 and entitled “CONSENSUS METHOD AND APPARATUS FOR BLOCKCHAIN, COMPUTER-READABLE MEDIUM, AND ELECTRONIC DEVICE”, the entire contents of all of which are incorporated herein by reference.

### FIELD OF THE TECHNOLOGY

The present disclosure relates to the field of computers and communication technologies, and in particular, to a consensus method and apparatus for a blockchain, a computer-readable medium, and an electronic device.

### BACKGROUND OF THE DISCLOSURE

In blockchain technologies, a consensus mechanism is a foundation for normal operation of a blockchain system. The consensus means reaching an agreement. Each blockchain node in the blockchain system has a distributed ledger (that is, a blockchain) stored herein. A consensus reaching process of the blockchain system is a process of keeping the distributed ledgers of the blockchain nodes consistent with each other. A Byzantine fault tolerance (BFT) consensus algorithm is a commonly used consensus algorithm in the blockchain technologies. Each block needs to go through three stages: a proposal stage, a prevote stage, a precommit stage If a proposal node fails, all other blockchain nodes need to vote for an empty block after timeout waiting. In addition, when serving as a proposal node next time, the blockchain node still needs to go through timeout waiting of long duration. Consequently, the consensus reaching process consumes a long time, and consensus performance of the blockchain is affected.

### SUMMARY

Embodiments of the present disclosure provide a consensus method and apparatus for a blockchain, a computer-readable medium, and an electronic device, to reduce time consumption of consensus for the blockchain, so as to help improve consensus performance of the blockchain.

Other features and advantages of the present disclosure become clear through the following detailed descriptions or partially learned through practice of the present disclosure.

According to an aspect of the embodiments of the present disclosure, a consensus method for a blockchain is provided, the method being performed by a blockchain node in a blockchain network, and including: obtaining, based on recorded proposal waiting parameters corresponding to blockchain nodes, a proposal waiting parameter corresponding to a current proposal node in the blockchain nodes; determining, based on the proposal waiting parameter corresponding to the current proposal node, proposal waiting duration corresponding to the current proposal node; and adjusting, in response to a proposal message initiated by the current proposal node is not received within the proposal waiting duration at a proposal stage of the current proposal node, the proposal waiting parameter corresponding to the current proposal node to reduce the proposal waiting duration corresponding to the current proposal node.

According to an aspect of the embodiments of the present disclosure, a consensus apparatus for a blockchain is provided, the apparatus being deployed on a blockchain node in a blockchain network, and including: an obtaining unit, configured to obtain, based on recorded proposal waiting parameters corresponding to blockchain nodes, a proposal waiting parameter corresponding to a current proposal node in the blockchain nodes; a determining unit, configured to determine, based on the proposal waiting parameter corresponding to the current proposal node, proposal waiting duration corresponding to the current proposal node; and a processing unit, configured to adjust, in response to a proposal message initiated by the current proposal node is not received within the proposal waiting duration at a proposal stage of the current proposal node, the proposal waiting parameter corresponding to the current proposal node to reduce the proposal waiting duration corresponding to the current proposal node.

According to an aspect of the embodiments of the present disclosure, a non-transitory computer-readable medium is provided, the computer-readable medium having a computer program stored herein, and the computer program, when being executed by a processor, implementing the consensus method for the blockchain according to the foregoing embodiment.

According to an aspect of the embodiments of the present disclosure, an electronic device is provided, including: one or more processors; a storage apparatus, configured to store one or more computer programs, the one or more computer programs, when being executed by the one or more processors, enabling the electronic device to implement the consensus method for the blockchain according to the foregoing embodiment.

In a technical solution provided in some embodiments of the present disclosure, a proposal waiting parameter corresponding to a current proposal node is obtained. Proposal waiting duration corresponding to the current proposal node is determined based on the proposal waiting parameter corresponding to the current proposal node. Then, in response to a proposal message initiated by the current proposal node is not received within the proposal waiting duration at a proposal stage of the current proposal node, the proposal waiting parameter corresponding to the current proposal node is adjusted, to reduce the proposal waiting duration corresponding to the current proposal node. In this way, when the current proposal node serves as a proposal node again, duration for which another node waits for receiving the proposal message can be reduced. Therefore, time consumption of consensus for a blockchain can be reduced, to help improve consensus performance of the blockchain.

The foregoing general descriptions and the following detailed descriptions are merely exemplary and explanatory, and the present disclosure is not limited thereto.

### BRIEF DESCRIPTION OF THE DRAWINGS

FIG. 1 is a schematic diagram of a structure of a blockchain network.

FIG. 2 is a schematic diagram of a connection relationship between blocks in a blockchain.

FIG. 3 is a schematic flowchart of a BFT consensus algorithm.

FIG. 4 is a schematic diagram of block broadcasting by a consensus node according to an embodiment of the present disclosure.

FIG. 5 is a schematic diagram of a processing process of each consensus stage of a BFT consensus algorithm.

FIG. 6 is a flowchart of a consensus method for a blockchain according to an embodiment of the present disclosure.

FIG. 7 is a schematic diagram of a processing process of each consensus stage in a consensus reaching process according to an embodiment of the present disclosure.

FIG. 8 is a schematic diagram of a processing process of each consensus stage in a consensus reaching process according to an embodiment of the present disclosure.

FIG. 9 is a block diagram of a consensus apparatus for a blockchain according to an embodiment of the present disclosure.

FIG. 10 is a schematic diagram of a structure of a computer system of an electronic device configured to implement an embodiment of the present disclosure.

### DESCRIPTION OF EMBODIMENTS

Exemplary implementations are described more comprehensively below with reference to the accompanying drawings. However, the exemplary implementations can be implemented in various forms, and are not to be understood as being limited to these examples. Conversely, these implementations are provided to make the present disclosure more comprehensive and complete, and comprehensively convey the idea of the exemplary implementations to a person skilled in the art.

In addition, the described features, structures, or characteristics in the present disclosure may be combined in one or more embodiments in any appropriate manner. In the following descriptions, more details are provided to provide a comprehensive understanding of embodiments of the present disclosure. However, a person skilled in the art is to be aware that, a technical solution in the present disclosure may be implemented without using all detailed features in the embodiments, and one or more specific details may be omitted, or another method, element, apparatus, or operation may be used.

Block diagrams shown in the accompany drawings are merely functional entities and do not necessarily correspond to physically independent entities. To be specific, such functional entities may be implemented in a form of software, or implemented in one or more hardware modules or integrated circuits, or implemented in different networks and/or processor apparatuses and/or microcontroller apparatuses.

Flowcharts shown in the accompanying drawings are merely examples for descriptions, do not necessarily include all content and operations/steps, and are not necessarily performed in the described orders. For example, some operations/steps may be further divided, while some operations/steps may be combined or partially combined. Therefore, an actual execution order may change based on an actual situation.

“A plurality of” mentioned herein means two or more. “And/or” describes an association relationship for describing associated objects and represents that three relationships may exist. For example, A and/or B may represent the following three cases: Only A exists, both A and B exist, and only B exists. The character “/” generally represents an “or” relationship between the associated objects.

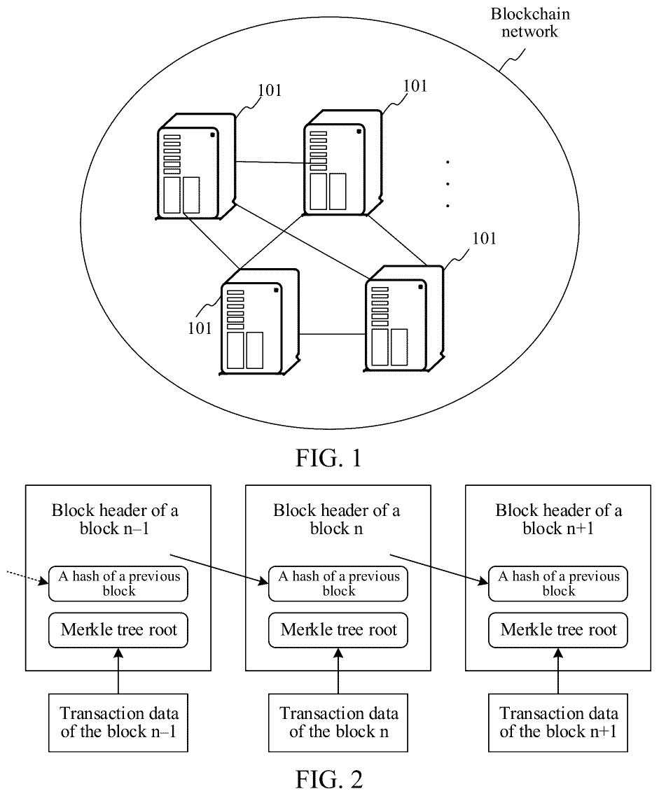

The technical solutions in the embodiments of the present disclosure relate to blockchain technologies. Specifically, a blockchain is a new application mode of computer technologies such as distributed data storage, peer-to-peer transmission, a consensus mechanism, and an encryption algorithm. The blockchain is essentially a decentralized database, and the blockchain is jointly maintained by blockchain nodes in a blockchain network, and the blockchain node may also be referred to as a node for short. For example, a blockchain network shown in FIG. 1 may include a plurality of nodes 101, and the plurality of nodes 101 may be clients included in the blockchain network. Each node 101 may receive input information during normal work, and maintains shared data in the blockchain network based on the received input information. To ensure interworking of information in the blockchain network, all the nodes in the blockchain network may have an information connection between each other, and information may be transmitted among the nodes through the information connection. For example, when any node in the blockchain network receives input information, other nodes in the blockchain network obtain the input information based on a consensus algorithm, and store the input information as shared data, so that data stored in all the nodes in the blockchain network is consistent.

Each node in the blockchain network has a node identity corresponding to the node, and each node in the blockchain network can store node identities of other nodes, so that a generated block can be subsequently broadcast to the other nodes in the blockchain network based on the node identities of the other nodes. Each node may maintain a node identity list, and correspondingly store a node name and the node identity in the node identity list. The node identity may be an internet protocol (IP) address and any other information that can be configured for identifying the node.

Each node in the blockchain network stores a same blockchain. The blockchain includes a plurality of blocks. Referring to FIG. 2, the blockchain includes a plurality of blocks, and the blocks are connected in a structure of a chain in ascending order of creation timestamps. Each block includes a block header and a block body. A hash of a previous block and a Merkle tree root of the block are stored in the block header. Complete transaction data of the block is included in the block body and is organized together in a form of a Merkle tree. It can be learned from the structure of the blockchain that block data stored in each block in the blockchain is associated with block data stored in a parent block (that is, the previous block), to ensure security of the input information in the block.

Each node in the blockchain network may be a server, or may be a terminal device. The server may be an independent physical server, or may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal device may be a smartphone, a tablet computer, a notebook computer, a desktop computer, a smart speaker, a smartwatch, a smart household, a vehicle-mounted terminal, an aircraft, or the like, but is not limited thereto. The nodes may be directly or indirectly connected to each other through wired or wireless communication. This is not limited in the present disclosure.

The Merkle tree is an important component of the blockchain technologies. The blockchain does not directly store original data in plaintext, and the original data needs to be hashed to be stored in a form of a hash value. The Merkle tree is configured for organizing, based on a structure of a binary tree, hash values formed by performing hash computing on a plurality of pieces of original data, and storing the hash values in the block body of the block.

There is also a key technology in the blockchain technologies, namely, a consensus mechanism. The consensus mechanism is a foundation for normal operation of a blockchain system. The so-called consensus means reaching an agreement. Each node device in the blockchain system has a distributed ledger (that is, a blockchain) stored herein. A consensus reaching process of the blockchain system is a process of keeping the distributed ledgers of the node devices consistent with each other. All or a part of the node devices in the blockchain system may participate in the consensus reaching process of the blockchain system. The consensus reaching process of the blockchain system is usually implemented based on a consensus algorithm. Each node device that participates in the consensus reaching runs the consensus algorithm to perform a corresponding procedure of the consensus reaching process. For example, exemplary consensus algorithms may include a proof of work (PoW), a proof of stake (POS), a delegated proof of stake (DPOS), Byzantine fault tolerance (BFT), and practical Byzantine fault tolerance (PBFT).

Generally, one or more rounds of consensus reaching processes need to be performed at a block height of the blockchain to reach an agreement among the node devices that participate in the consensus. The block height is configured for representing a quantity of blocks connected to the blockchain. The block height is an identifier of a block and may be configured for indicating a position of the block in the blockchain. For example, a block height of a genesis block in the blockchain is 0 by default, a block height of the 1^{st} block after the genesis block is 1 (where the 1^{st} block may be referred to as a block 1 for short), a block height of the 2^{nd} block after the genesis block is 2 (where the 2^{nd} block may be referred to as a block 2 for short), and so on.

For example, when a block height of a current block in a blockchain is 300 (where the block is referred to as a block 300 for short), it indicates that 300 blocks are already stacked on a genesis block. In other words, a quantity of blocks on the blockchain starting from the genesis block to the block 300 is 301. A consensus reaching process performed at a block height of the blockchain is a process of reaching consensus with a to-be-chained block in the blockchain system when the blockchain is at the block height. If the consensus with the to-be-chained block is successfully reached, the block is added to the blockchain, and the block height of the blockchain is increased by 1. For example, a consensus reaching process at a block height of 10 of the blockchain is a process of reaching consensus with a to-be-chained block in the blockchain system when the blockchain is at the block height of 10. If the consensus with the block is successfully reached, the block is added to the blockchain, so that the block height of the blockchain changes from 10 to 11.

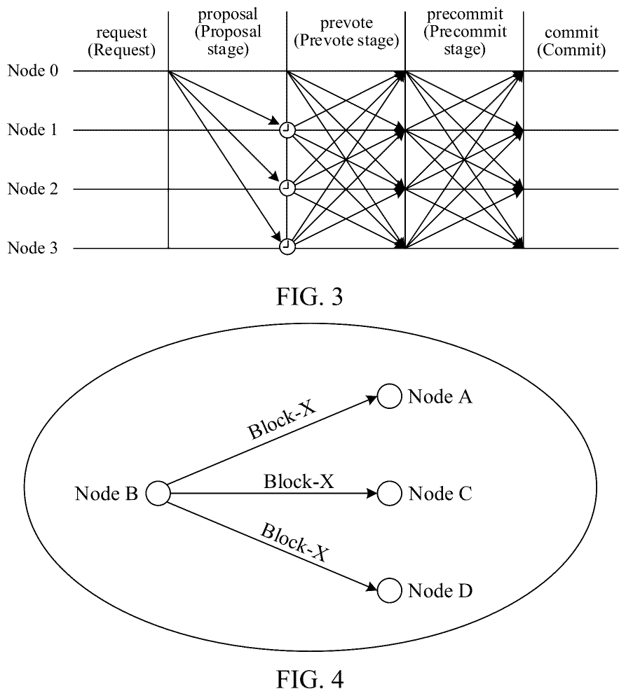

Generally, as shown in FIG. 3, a round of consensus reaching process may be sequentially divided into three consensus stages according to an execution sequence, to be specific, a proposal stage, a prevote stage, and a precommit stage. A plurality of nodes that participate in a same round of consensus reaching process includes a proposal node and a non-proposal node. The proposal node is a node elected by a plurality of node devices that participate in consensus. The node serving as the proposal node is responsible for generating, based on a request, a block with which consensus is to be reached at the proposal stage of this round of consensus reaching process, and broadcasting, for consensus processing, the block with which consensus is to be reached to other nodes that participate in consensus. In addition, the proposal node is also responsible for performing consensus processing on the block with which consensus is to be reached. The non-proposal node only performs consensus processing on the block with which consensus is to be reached.

The consensus processing includes prevote processing and precommit processing. The prevote processing occurs in the prevote stage, and the precommit processing occurs in the precommit stage. The prevote processing refers to a process of determining whether to agree to perform prevote on the block with which consensus is to be reached. If it is agreed to perform prevote on the block with which consensus is to be reached, it indicates that the block is agreed to be added to the blockchain. The precommit processing refers to a process of determining whether to agree to perform precommit on the block with which consensus is to be reached. If it is agreed to perform precommit on the block with which consensus is to be reached, it indicates that it is confirmed that the block is agreed to be added to the blockchain. In a plurality of rounds of consensus reaching processes performed at a same block height, for different rounds of consensus reaching processes, nodes that participate in the consensus reaching may change. In other words, nodes that participate in each round of consensus reaching process may change, a proposal node may change, and the block with which consensus is to be reached may also change.

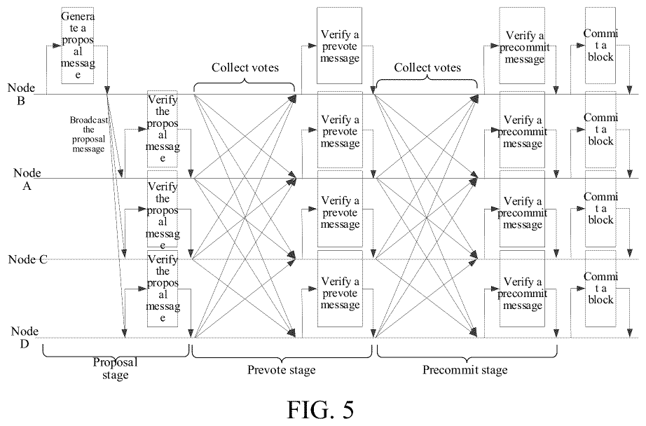

The following describes in detail, by using a specific example, a specific procedure of an (N−i)^{th} round of consensus reaching process at a block height of H of the blockchain in this embodiment of the present disclosure, where H, N, and i are all positive integers, and i is less than N. Using i=1 as an example, in the (N−1)^{th} round of consensus reaching process at the block height of H of the blockchain, there are four nodes in total participating in the consensus reaching process. FIG. 4 is a schematic diagram of block broadcasting by a consensus node according to an embodiment of the present disclosure. As shown in FIG. 4, nodes participating in the consensus reaching process in the blockchain system are respectively a node A, a node B, a node C, and a node D. In the (N−1)^{th} round of consensus reaching process at the block height of H of the blockchain, the node B is a proposal node, and the node A, the node C, and the node D are non-proposal nodes. Referring to FIG. 5, the specific procedure of the (N−1)^{th} round of consensus reaching process at the block height of H of the blockchain includes:

### 1. Proposal Stage

First, the node B (that is, the proposal node) generates a target block Block-X with which consensus is to be reached, and the Block-X may be a new block created by the node B. Then, the node B generates a proposal message for the target block Block-X, and broadcasts the proposal message to the node A, the node C, and the node D.

### 2. Prevote Stage

Due to a network failure, a device failure, or another reason, some nodes cannot receive, within first duration, the Block-X broadcast by the node B. For example, it is assumed that the node A does not receive, within the first duration, the Block-X broadcast by the node B, and the node C and the node D both receive, within the first duration, the Block-X broadcast by the node B. In this case, at the prevote stage, the node B, the node C, and the node D all use the Block-X as the target block with which consensus is to be reached, and perform prevote processing on the Block-X to obtain respective prevote messages. The prevote messages include an identifier of the block on which prevote processing is performed. For example, the node C performs prevote processing on the Block-X to generate a prevote message of the node C. The prevote message of the node C includes an identifier of the Block-X, and the prevote message indicates that the node C agrees to perform prevote on the Block-X, that is, agrees to add the Block-X to the blockchain. The Block-X obtains a prevote of the node C.

If the node C does not generate the prevote message of the node C, it indicates that the node C does not perform prevote processing on the Block-X. If the prevote message of the node C does not include the identifier of the Block-X, it indicates that the node C does not agree to perform prevote on the Block-X, that is, does not agree to add the Block-X to the blockchain. Because the node A does not receive the Block-X within the first duration, the node A may determine an empty block as a target block with which consensus is to be reached, and perform prevote processing on the empty block to obtain a prevote message of the node A. The prevote message of the node A includes an identifier of the empty block. The first duration may be set based on an actual requirement, for example, may be set to 1 minute or 3 minutes.

The node A, the node B, the node C, and the node D each broadcast the respective prevote messages. Due to a network failure, a device failure, or another reason, some nodes may not receive, within second duration, prevote messages broadcast by other nodes. Therefore, when the second duration passes, the nodes that participate in the consensus reaching process respectively count, based on the prevote messages received within the second duration, a quantity of prevotes obtained, at the prevote stage, by the target block with which consensus is to be reached, and determine whether the quantity of the prevotes exceeds a quantity threshold. The quantity threshold may be set based on an actual situation. For example, the quantity threshold may be 50% of a quantity of the nodes participating in the consensus reaching process, or ⅔ (or ⅔+1) of the quantity of the nodes participating in the consensus reaching process. The second duration may also be set based on an actual requirement, for example, may be set to 1 minute or 3 minutes. The second time may be the same as the first duration, or may be different from the first duration.

For example, the quantity threshold is set to 2. Because the node A performs prevote processing only on the empty block, the prevote message of the node A includes the identifier of the empty block. The node B, the node C, and the node D all perform prevote processing on the Block-X, and the prevote messages of the node B, the node C, and the node D all include the identifier of the Block-X. In addition, assuming that the node A receives only the prevote message from the node B, the quantity of the prevotes obtained by the Block-X at the prevote stage is obtained through statistics in combination with the prevote message of the node A, and is 1, and then it is determined that the quantity of the prevotes obtained by the Block-X does not exceed the quantity threshold of 2. Assuming that the node B receives three prevote messages from the node A, the node C, and the node D, the quantity of the prevotes obtained by the Block-X is obtained through statistics in combination with the prevote message of the node B, and is 3, and then it is determined that the quantity of the prevotes obtained by the Block-X exceeds the quantity threshold of 2. Similarly, assuming that the node C receives three prevote messages from the node A, the node B, and the node D, the quantity of the prevotes obtained by the Block-X is obtained through statistics in combination with the prevote message of the node C, and is 3, and then it is determined that the quantity of the prevotes obtained by the Block-X exceeds the quantity threshold of 2. Assuming that the node D also receives three prevote messages from the node A, the node B, and the node C, the quantity of the prevotes obtained by the Block-X is obtained through statistics in combination with the prevote message of the node D, and is 3, and then it is determined that the quantity of the prevotes obtained by the Block-X exceeds the quantity threshold of 2.

### 3. Precommit Stage

The node B, the node C, and the node D all determine the Block-X as the target block with which consensus is to be reached. Therefore, the nodes all perform precommit processing on the Block-X to obtain respective precommit voting messages. The precommit voting message includes an identifier of a block on which precommit processing is performed. For example, the node C performs precommit processing on the Block-X to generate a precommit voting message of the node C. The precommit voting message includes the identifier of the Block-X, and the precommit voting message indicates that the node C agrees to perform precommit on the Block-X, that is, indicates that the node C confirms to agree to add the Block-X to the blockchain. The Block-X obtains a precommit of the node C.

If the node C does not generate the precommit voting message of the node C, it indicates that the node C does not perform precommit processing on the Block-X. If the precommit voting message of the node C does not include the identifier of the Block-X, it indicates that the node C does not agree to perform precommit on the Block-X, that is, does not agree to add the Block-X to the blockchain. Because the node A determines the empty block as the target block with which consensus is to be reached, the node A performs precommit processing on the empty block to obtain a precommit voting message of the node A. The precommit voting message of the node A includes the identifier of the empty block.

The node A, the node B, the node C, and the node D each broadcasts the respective precommit voting messages. Due to a network failure, a device failure, or another reason, some nodes cannot receive, within third duration, precommit voting messages broadcast by other nodes. When the third duration passes, the nodes that participate in the consensus reaching process respectively count, based on the precommit voting messages received within the third duration, a quantity of precommits obtained, at the precommit stage, by the target block with which consensus is to be reached, and determine whether the quantity of the precommits exceeds a commit threshold. The commit threshold may be set based on an actual situation. For example, the commit threshold may be 50% of the quantity of the nodes participating in the consensus reaching process, or ⅔ (or ⅔+1) of the quantity of the nodes participating in the consensus reaching process. The third duration may also be set based on an actual requirement, for example, may be set to 1 minute or 3 minutes. The third duration may be the same as the second duration, or may be different from the second duration. Similarly, the third duration may be the same as the first duration, or may be different from the first duration.

For example, the commit threshold is set to 2. Because the node A performs precommit processing only on the empty block, the precommit voting message of the node A includes the identifier of the empty block. The node B, the node C, and the node D all perform precommit processing on the Block-X, and the precommit voting messages of the node B, the node C, and the node D all include the identifier of the Block-X. In addition, assuming that the node B receives precommit voting messages from the node A and the node C, the quantity of the precommits obtained by the Block-X at the precommit stage is obtained through statistics in combination with the precommit voting message of the node B, and is 2, and then it is determined that the quantity of the precommits obtained by the Block-X does not exceed (is not greater than) the commit threshold of 2. Assuming that the node C receives precommit voting messages from the node A and the node B, the quantity of the precommits obtained by the Block-X at the precommit stage is obtained through statistics in combination with the precommit voting messages of the node C, and is 2, and then it is determined that the quantity of the precommits obtained by the Block-X does not exceed (is not greater than) the commit threshold of 2. Similarly, assuming that the node A receives three precommit voting messages from the node B, the node C, and the node D, the quantity of the precommits obtained by the Block-X is obtained through statistics in combination with the precommit voting message of the node A, and is 3, and then it is determined that the quantity of the precommits obtained by the Block-X exceeds the commit threshold of 2. Assuming that the node D also receives three precommit voting messages from the node A, the node B, and the node C, the quantity of the precommits obtained by the Block-X is obtained through statistics in combination with the precommit voting message of the node D, and is 3, and then it is determined that the quantity of the precommits obtained by the Block-X exceeds the commit threshold of 2.

After the foregoing three consensus stages, if the quantity of the prevotes obtained by the target block with which consensus is to be reached exceeds the quantity threshold, and the quantity of the obtained precommits exceeds the commit threshold, consensus with the target block with which consensus is to be reached is successfully reached and the target block can be added to the blockchain. In other words, commit processing may be performed. Otherwise, consensus fails to be reached and the target block cannot be added to the blockchain According to the foregoing examples, the node A confirms that the quantity of the precommits obtained by the Block-X exceeds the commit threshold, but the quantity of the obtained prevotes does not exceed the quantity threshold. Therefore, it is determined that consensus with the Block-X fails to be reached. The node B confirms that the quantity of the prevotes obtained by the Block-X exceeds the quantity threshold, but the quantity of the obtained precommits does not exceed the commit threshold. Therefore, it is determined that consensus with the Block-X fails to be reached. The node C confirms that the quantity of the prevotes obtained by the Block-X exceeds the quantity threshold, but the quantity of the obtained precommits does not exceed the commit threshold. Therefore, it is determined that consensus with the Block-X fails to be reached. The node D confirms that the quantity of the prevotes obtained by the Block-X exceeds the quantity threshold, and the quantity of the obtained precommits exceeds the commit threshold. Therefore, it is determined that consensus with the Block-X is successfully reached. The node D adds the Block-X to a blockchain that is locally stored by the node D.

In conclusion, in the (N−1)^{th} round of consensus reaching process at the block height of H of the blockchain, the node A, the node B, and the node C do not reach consensus with the Block-X, and do not write the Block-X into respective distributed ledgers (that is, do not add the Block-X to respective blockchains that are locally stored). However, the node D reaches consensus with the Block-X, and writes the Block-X into a distributed ledger of the node D, so that a block height that is locally stored by the node D and that is of the blockchain is changed to H+1. In an N^{th} round of consensus reaching process at the block height of H of the blockchain, the node D no longer participates in consensus reaching, and the nodes that participate in the consensus reaching are changed to the node A, the node B, and the node C.

In the N^{th} round of consensus reaching process at the block height of H of the blockchain, the proposal node may be changed. For example, in the foregoing example, the proposal node in the (N−1)^{th} round of consensus reaching process at the block height of H of the blockchain is the node B, while the proposal node in the N^{th} round of consensus reaching process at the block height of H of the blockchain may be changed to the node C. Then, the foregoing three consensus stages are performed again, to complete the N^{th} round of consensus reaching process at the block height of H of the blockchain.

It can be learned from the foregoing consensus mechanism that, each block needs to go through the three stages: the proposal stage, the prevote stage, and the precommit stage. To ensure that an algorithm can be stably run, each node has a timer at the proposal stage (where timeout duration is generally set to a large value, such as 30s, to ensure that a proposal node can completely construct a proposal message), configured to wait for the proposal node to generate the proposal message. If another node does not receive, within fixed duration, the proposal message constructed by the proposal node, to ensure that the algorithm can continue to be run and a next round of consensus reaching can be started as soon as possible, the another node votes for an empty proposal message. Therefore, if a proposal node in the blockchain network does not generate a proposal message or another node does not receive the proposal message initiated by the proposal node, consensus with an empty proposal message is reached according to a consensus reaching procedure. Then, another node is switched to become a proposal node. If a node is down or is shut down for another reason at this time, and the node serves as a proposal node, because the node is down or shut down, another node does not receive a proposal message generated by the node, the another node waits for a time period and then casts a blank vote (e.g., votes for an empty proposal message, submits a block or vote that does not include any transactions). Then a normal node is switched to become a proposal node. In this case, the normal node generates a proposal message to allow the consensus reaching to continue.

It can be learned that, if a node is down or shut down, and the node becomes a proposal node, no proposal message is generated and sent to another node for performing consensus reaching. As a result, when this failed node becomes the proposal node, there is no proposal message for consensus reaching in the entire blockchain network. Consequently, another node needs to wait for timeout duration and cast a blank vote to reach a null/empty consensus (e.g., reach consensus with the empty proposal message). Then, a normal node is switched to become a proposal node. When an effective proposal message is generated, consensus that there is a proposal is reached. However, when the failed node becomes the proposal node next time, the another node need to wait long duration again. As a result, consensus performance of the blockchain is seriously affected.

Based on the foregoing technical problem, an embodiment of the present disclosure provides a new solution for reaching consensus for a blockchain, to reduce time consumption of the consensus for the blockchain, thereby helping improve consensus performance of the blockchain. Specifically, for any blockchain node in the blockchain network, proposal waiting parameters corresponding to blockchain nodes may be recorded. When a node serves as a current proposal node, proposal waiting duration corresponding to the current proposal node may be determined based on a proposal waiting parameter corresponding to the current proposal node. Then, in response to a proposal message initiated by the current proposal node is not received within the proposal waiting duration at a proposal stage of the current proposal node, the proposal waiting parameter corresponding to the current proposal node is adjusted, to reduce the proposal waiting duration corresponding to the current proposal node. In this way, when the current proposal node serves as the proposal node again, duration for which another node waits for receiving the proposal message can be reduced. Therefore, time consumption of consensus for the blockchain can be reduced, to help improve consensus performance of the blockchain.

The following describes various implementation details of the technical solution in the embodiments of the present disclosure.

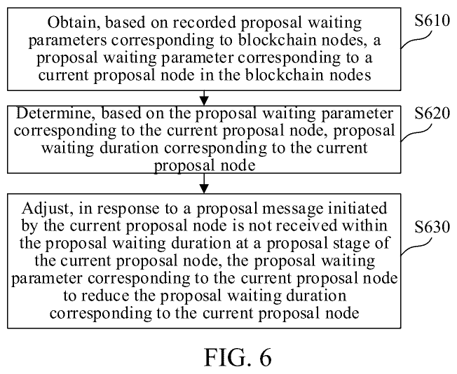

FIG. 6 is a flowchart of a consensus method for a blockchain according to an embodiment of the present disclosure. The consensus method for the blockchain may be performed by a blockchain node. Specifically, as shown in FIG. 6, the consensus method for the blockchain includes at least S610 to S630, which are described in detail as follows:

S610: Obtain, based on recorded proposal waiting parameters corresponding to blockchain nodes, a proposal waiting parameter corresponding to a current proposal node in the blockchain nodes.

In some embodiments, each blockchain node in a blockchain network may locally record the proposal waiting parameters corresponding to the blockchain nodes. The proposal waiting parameter is configured for determining proposal waiting duration. For example, the proposal waiting parameter may be a parameter value. In this case, when a blockchain node serves as a proposal node, corresponding proposal waiting duration may be determined based on the parameter value. The proposal waiting parameter may alternatively be a duration parameter. In this case, the duration parameter may be directly used as the corresponding proposal waiting duration.

In some embodiments, each blockchain node may initially generate a proposal waiting parameter table. The proposal waiting parameter table includes default proposal waiting parameters set for the blockchain nodes in the blockchain network.

S620: Determine, based on the proposal waiting parameter corresponding to the current proposal node, proposal waiting duration corresponding to the current proposal node.

In this embodiment of the present disclosure, the proposal waiting duration may be determined based on the proposal waiting parameter in a plurality of manners. Generally, the proposal waiting duration may be determined in different manners based on different proposal waiting parameters.

In some embodiments, the proposal waiting parameter may be a parameter value. In this case, when the proposal waiting duration corresponding to the current proposal node is to be determined, a difference between a parameter value corresponding to each of other blockchain nodes and a parameter value corresponding to the current proposal node may be determined. In response to a quantity of other blockchain nodes whose differences are greater than or equal to a set threshold is greater than or equal to a set quantity, set duration is determined as the proposal waiting duration corresponding to the current proposal node. The set duration is shorter than default proposal waiting duration of the blockchain network. The default proposal waiting duration may be set based on an actual requirement, for example, may be 30 s. The set threshold and the set duration may also be set according to an actual requirement. For example, the set threshold may be 5, and the set duration may be ⅓ or a half of the default proposal waiting duration.

Based on the technical solution of the foregoing embodiment, if the quantity of the other blockchain nodes whose differences with the parameter value corresponding to the current proposal node are greater than or equal to the set threshold is less than the set quantity, the default proposal waiting duration is used as the proposal waiting duration corresponding to the current proposal node. In some embodiments, if the quantity of the other blockchain nodes whose differences with the parameter value corresponding to the current proposal node are greater than or equal to the set threshold is less than the set quantity, the proposal waiting duration corresponding to the current proposal node may be properly reduced. For example, the proposal waiting duration corresponding to the current proposal node is set to a half or ¾ of the default proposal waiting duration.

In some embodiments, the proposal waiting parameter may be a parameter value. In this case, the proposal waiting duration corresponding to the current proposal node may be determined based on a mapping relationship between the parameter value and duration. Specifically, duration searching is performed based on the mapping relationship between the parameter value and the duration, to obtain duration that has a mapping relationship with a parameter value corresponding to the current proposal node. In this way, the duration that has the mapping relationship with the parameter value corresponding to the current proposal node is determined as the proposal waiting duration corresponding to the current proposal node. For example, the mapping relationship between the parameter value and the duration may be preset. In an example, if the parameter value is 10, the corresponding proposal waiting duration is default proposal waiting duration; if the parameter value is 9, the corresponding proposal waiting duration is 9/10 of the default proposal waiting duration; if the parameter value is 8, the corresponding proposal waiting duration is 8/10 of the default proposal waiting duration; and so on. In this case, the proposal waiting duration corresponding to the current proposal node may be determined based on the parameter value corresponding to the current proposal node.

In another example, the mapping relationship between the parameter value and the duration may alternatively be as follows: If the parameter value is 6 to 10, the corresponding proposal waiting duration is the default proposal waiting duration; if the parameter value is 0 to 5, the corresponding proposal waiting duration is ⅓ of the default proposal waiting duration; and so on.

In some embodiments, the proposal waiting parameter may be a duration parameter. In this case, when the proposal waiting duration corresponding to the current proposal node is determined, a duration parameter corresponding to the current proposal node may be used as the proposal waiting duration corresponding to the current proposal node. In other words, in this embodiment, the proposal waiting parameters corresponding to each blockchain node is an actual duration parameter. In this case, the duration parameter may be directly used as the proposal waiting duration.

S630: Adjust, in response to a proposal message initiated by the current proposal node is not received within the proposal waiting duration at a proposal stage of the current proposal node, the proposal waiting parameter corresponding to the current proposal node to reduce the proposal waiting duration corresponding to the current proposal node.

In some embodiments, a process of adjusting, when the proposal message initiated by the current proposal node is not received within the proposal waiting duration, the proposal waiting parameter corresponding to the current proposal node may be as follows: When the proposal message initiated by the current proposal node is not received within the proposal waiting duration, a value of the proposal waiting parameter corresponding to the current proposal node is reduced based on a first set step length, until the value reaches a minimum value. For example, a value of a proposal waiting parameter corresponding to a blockchain node A is 5. When the blockchain node A serves as a proposal node, another blockchain node does not receive, within the proposal waiting duration, a proposal message broadcast by the blockchain node A. In this case, the value of the proposal waiting parameter corresponding to the blockchain node A may be adjusted to 4. In this case, the first set step length is 1 (where certainly, the first set step length may alternatively be another value). In some embodiments, the minimum value may be 0.

In some embodiments, when the proposal message initiated by the current proposal node is received within the proposal waiting duration, the proposal waiting parameter corresponding to the current proposal node may be adjusted to maintain or increase the proposal waiting duration corresponding to the current proposal node. In this embodiment, in response to the proposal message initiated by the current proposal node is received within the proposal waiting duration, it indicates that the proposal node is normal, and the proposal waiting duration corresponding to the current proposal node may be maintained. For a blockchain node whose proposal waiting duration has been reduced previously, the corresponding proposal waiting duration may be properly increased.

In some embodiments, when the proposal message initiated by the current proposal node is received within the proposal waiting duration, the process of adjusting the proposal waiting parameter corresponding to the current proposal node may include increasing, based on a second set step length, the value of the proposal waiting parameter corresponding to the current proposal node, until the value reaches a maximum value. For example, the value of the proposal waiting parameter corresponding to the blockchain node A is 5. When the blockchain node A serves as the proposal node, the another blockchain node receives, within the proposal waiting duration, the proposal message broadcast by the blockchain node A. In this case, the value of the proposal waiting parameter corresponding to the blockchain node A may be adjusted to 6. In this case, the second set step length is 1 (where certainly, the set step may alternatively be another value). In some embodiments, the maximum value may be 10.

In this embodiment of the present disclosure, values of the first set step length and of the second set step length may be the same, or may be different. This is not limited in this embodiment of the present disclosure.

In some embodiments, when the proposal message initiated by the current proposal node is received within the proposal waiting duration, the proposal waiting parameter corresponding to the current proposal node may not be adjusted first. Instead, the proposal waiting parameter corresponding to the current proposal node is adjusted after consensus with a block targeted by the proposal message initiated by the current proposal node is reached. In this way, impact caused by an illegal proposal message initiated by the current proposal node may be excluded.

In some embodiments, a normal blockchain node adjusts, based on whether the normal blockchain node receives a proposal message initiated by a proposal node, a proposal waiting parameter corresponding to the blockchain node, while a blockchain node in an abnormal state (for example, the blockchain node is down or suffers a network failure) cannot perform adjustment in time. Therefore, when the blockchain node recovers from the abnormal state to a normal state, to update the locally recorded proposal waiting parameters corresponding to the blockchain nodes, the blockchain node synchronizes with, from the other blockchain nodes, proposal waiting parameters corresponding to the blockchain nodes. In the technical solution of this embodiment, a blockchain node that returns to normal is enabled to update the locally maintained proposal waiting parameters in time, to prevent affecting a consensus reaching process on a subsequent block, and help ensure consensus performance of the blockchain.

In the technical solution in the embodiments of the present disclosure, in response to the proposal message initiated by the current proposal node is not received within the proposal waiting duration at the proposal stage of the current proposal node, the proposal waiting parameter corresponding to the current proposal node is adjusted, to reduce the proposal waiting duration corresponding to the current proposal node. In this way, when the current proposal node serves as the proposal node again, duration for which another node waits for receiving the proposal message can be reduced. Therefore, time consumption of consensus for the blockchain can be reduced, to help improve consensus performance of the blockchain.

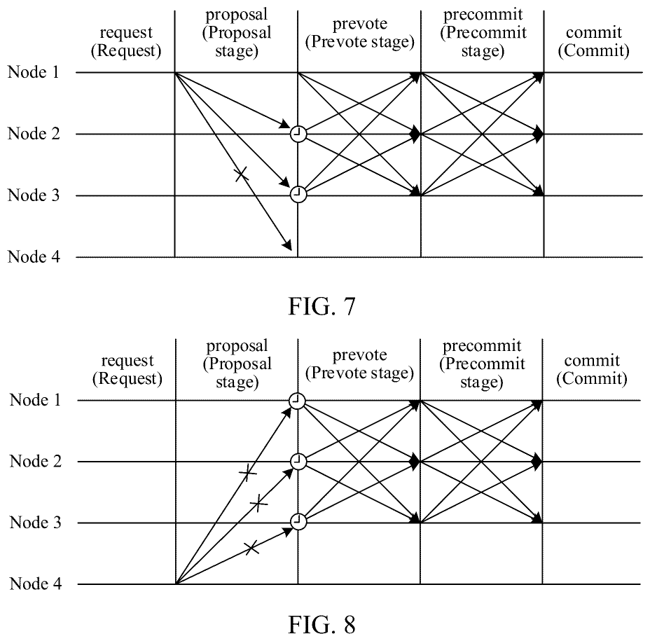

The following describes implementation details of the technical solution in this embodiment of the present disclosure again by using specific examples with reference to FIG. 7 and FIG. 8.

The technical solution in this embodiment of the present disclosure is mainly to adjust proposal waiting duration when a failed node serves as a proposal node, to prevent affecting consensus performance of a blockchain due to long waiting duration each time. Specifically, each node may maintain a map, that is, a proposal waiting parameter table. The map is configured for representing a mapping relationship between each node and proposal waiting duration corresponding to the node. A key of the map is a node identity (id) of the node, and is configured for indicating the node. A value is an integer, and represents the proposal waiting duration corresponding to the node. An initial value is 0. If consensus of an entire blockchain network is reached when a node serves as a proposal node, it indicates that the node is a normal node. In this case, in the respectively maintained map, each node increases a value of a key of the node by 1. If another node does not receive, within timeout waiting duration (that is, the proposal waiting duration), a proposal message generated by the proposal node, it can be considered that the node may fail. In this case, in the respectively maintained map, each node reduces the value of the node by 1. In some embodiments, a value of each key in the map may range from 0 to 10. In other words, if the value plus 1 is greater than 10, the value is set to 10. If the value minus 1 is less than 0, the value is set to 0.

Based on the foregoing maintained maps, if a node fails, a value of the node is continuously reduced and finally becomes 0. If the node is normal, the value corresponding to the node is continuously increased and finally becomes 10. When a node becomes a proposal node, another node obtains values of all node ids from a local map of the another node. If a value of an id of the proposal node is less than a value of the another node by over 5, and a quantity of nodes whose value differences are greater than 5 exceeds ⅔ of a total quantity of nodes, timeout duration for which the another node waits for a proposal message from the proposal node may be adjusted to ⅓ of default proposal waiting duration (where a specific value in this embodiment is merely an example).

It can be learned that, if a value of a node is less than values of most nodes (for example, ⅔ of the nodes) by over 5, when the node becomes a proposal node, timeout waiting duration for which another node waits for the node to generate a proposal message is ⅓ of normal timeout waiting duration. When this failed node returns to normal later, the node can normally generate the proposal message to reach consensus, and 1 is added to the value that is maintained by the another node and that corresponds to the failed node, so that the value gradually returns to normal. Therefore, the technical solution in this embodiment of the present disclosure can greatly improve performance of the entire blockchain network when a node fails.

As shown in FIG. 7, it is assumed that there are four nodes. Initially, all the nodes respectively maintain a map, and values of all nodes ids in the map are initialized to 0. It is assumed that a node 4 becomes a failed node because the node is down or due to another reason, other three nodes are normal nodes, consensus has been reached for a period of time, a value of the node 4 becomes 1, and values of the other three nodes are 9. In this case, a consensus reaching procedure of the four nodes is as follows:

Case in which a normal node becomes a proposal node (where for ease of description, an example in which a node 1 is the proposal node is used for description):

Because the node 1 is the normal node, the node 1 can generate a normal proposal message, and then broadcast proposal information to other nodes. As shown in FIG. 7, a node 2 and a node 3 are normal nodes, and the two nodes perform comparison based on values of all keys in local maps. Because the node 1 is the normal node, the value of each node id in the maps of the node 2 and node 3 is shown in the following Table 1.

TABLE 1

| Node ID | Value |
|---|---|
| Node 1 | 9 |
| Node 2 | 9 |
| Node 3 | 9 |
| Node 4 | 1 |

As shown in Table 1, because a quantity of nodes whose values are greater than a value of the node 1 does not exceed ⅔ of all the nodes, duration for which the node 2 and the node 3 wait for the node 1 to generate the proposal message is normal timeout waiting duration (which is recorded as timeout). Within the timeout duration, the node 2 and the node 3 can receive the proposal message generated by the node 1, then perform prevote voting on the proposal message, and finally reach consensus through precommit voting. After the consensus is reached, the value of the node 1 in the map of each node is added by 1. Because the value of the node 1 does not exceed 10, the values in the map maintained by each node after the consensus is reached are shown in the following Table 2.

TABLE 2

| Node ID | Value |
|---|---|
| Node 1 | 10 |
| Node 2 | 9 |
| Node 3 | 9 |
| Node 4 | 1 |

Case in which a failed node (that is, the node 4) becomes a proposal node:

Because the node 4 is the failed node, the node 4 cannot generate a proposal message. Therefore, the consensus reaching procedure is shown in FIG. 8. The normal node 1, node 2, and node 3 perform comparison based on the values of all the keys in respective local maps. Because the node 4 is the failed node, the value of each node id in the maps of the node 1, node 2, and node 3 is shown in the following Table 3.

TABLE 3

| Node ID | Value |
|---|---|
| Node 1 | 10 |
| Node 2 | 9 |
| Node 3 | 9 |
| Node 4 | 1 |

As shown in Table 3, a difference between the value of the node 4 and the value of the node 1 is 9, a difference between the value of the node 4 and the value of the node 2 is 8, a difference between the value of the node 4 and the value of the node 3 is 8, a total quantity of the nodes is 4, and a quantity of the other nodes whose value differences with the node 4 are greater than 5 is 3, where the quantity exceeds ⅔ of the quantity of the nodes. Therefore, timeout waiting duration for which the node 1, node 2, and node 3 wait for the proposal message of the node 4 is timeout/3. After the duration of timeout/3, the node 1, node 2, and node 3 cast blank votes, and finally reach consensus on an empty proposal message. After this round of consensus on the empty proposal message, each node reduces the value of the node 4 by 1 in the map. After the consensus is reached, the values in the map of each node are shown in the following Table 4.

TABLE 4

| Node ID | Value |
|---|---|
| Node 1 | 10 |
| Node 2 | 9 |
| Node 3 | 9 |
| Node 4 | 0 |

Because no valid consensus is reached when the node 4 serves as the proposal node, in a next round of consensus reaching, a normal node among the node 1, node 2, and node 3 becomes a proposal node and can normally generate a proposal message to perform consensus reaching.

As the consensus reaching continues, the values of the node 1, node 2, and node 3 continues to be increased to 10. However, the node 4 is the failed node, and the value of the node 4 is gradually reduced to 0. As a result, when the node 4 becomes the proposal node, the timeout waiting duration for which the node 1, node 2, and node 3 wait for the node 4 to generate the proposal message is ⅓ of the normal waiting timeout duration. In this case, for the consensus reaching process, when the failed node 4 becomes the proposal node, invalid waiting duration of the other nodes is reduced, and consensus performance of the blockchain is greatly improved.

If the failed node 4 is restarted and recovers at a time point, the node 4 starts to synchronize blocks with that in the other nodes. After the node 4 completes synchronization, if the node 4 becomes the proposal node and can generate the proposal message, after several times of consensus reaching, in the map of each node, the value of the node 4 is gradually increased to 10. In this way, all the nodes become normal nodes, and consensus performance of the system also recovers.

It can be learned that, in the embodiments of the present disclosure, if a node becomes a failed node, after several times of consensus reaching, a value of the node is gradually reduced until the value becomes 0. Therefore, when the node becomes a proposal node, duration for another node to wait for the node to generate a proposal message is very short. In this way, invalid waiting duration is reduced. When the failed node recovers and becomes a normal node and can generate the proposal message, after several consensus reaching processes, the value of the node is gradually increased to a normal value, and consensus performance of the blockchain system also returns to normal.

In the foregoing embodiment, the proposal waiting duration is adjusted by increasing or decreasing a value of a node. In another embodiment of the present disclosure, each node may alternatively record, in a local map, initial proposal waiting duration corresponding to each node. When a node serves as a proposal node, in response to a proposal message initiated by the proposal node is not received within the proposal waiting duration, the proposal waiting duration corresponding to the proposal node is gradually reduced, until the proposal waiting duration is reduced to a minimum value. In this way, invalid waiting duration of another node may also be reduced. When the failed node returns to a normal node and can generate the proposal message, the proposal waiting duration corresponding to the proposal node is gradually increased, until the proposal waiting duration is increased to a normal value. In this way, the consensus performance of the blockchain system also returns to normal.

The following describes apparatus embodiments of the present disclosure, which can be configured to perform the consensus method for the blockchain in the foregoing embodiments of the present disclosure. For details not disclosed in the apparatus embodiments of the present disclosure, refer to the foregoing embodiments of the consensus method for the blockchain in the present disclosure.

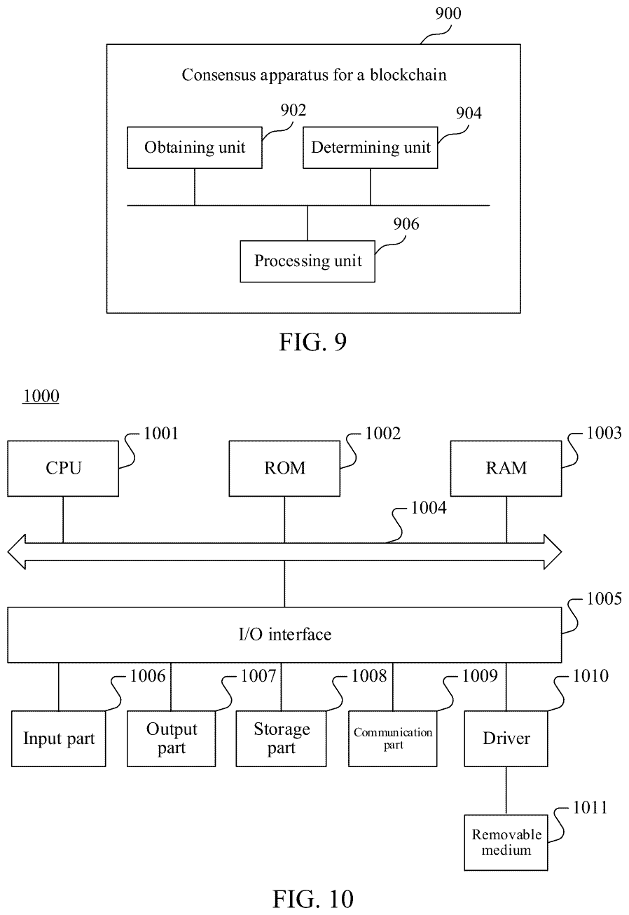

FIG. 9 is a block diagram of a consensus apparatus for a blockchain according to an embodiment of the present disclosure. The consensus apparatus for the blockchain may be configured in a blockchain node.

Referring to FIG. 9, a consensus apparatus 900 for a blockchain according to an embodiment of the present disclosure includes an obtaining unit 902, a determining unit 904, and a processing unit 906.

The obtaining unit 902 is configured to obtain, based on recorded proposal waiting parameters corresponding to blockchain nodes, a proposal waiting parameter corresponding to a current proposal node in the blockchain nodes. The determining unit 904 is configured to determine, based on the proposal waiting parameter corresponding to the current proposal node, proposal waiting duration corresponding to the current proposal node. The processing unit 906 is configured to adjust, in response to a proposal message initiated by the current proposal node is not received within the proposal waiting duration at a proposal stage of the current proposal node, the proposal waiting parameter corresponding to the current proposal node to reduce the proposal waiting duration corresponding to the current proposal node.

In some embodiments of the present disclosure, based on the foregoing solution, the proposal waiting parameter includes a parameter value. The determining unit 904 is configured to determine a difference between a parameter value corresponding to each of other blockchain nodes and a parameter value corresponding to the current proposal node, the other blockchain node being blockchain nodes other than the current proposal node in the blockchain network; and determine, in response to a quantity of other blockchain nodes whose differences are greater than or equal to a set threshold is greater than or equal to a set quantity, set duration as the proposal waiting duration corresponding to the current proposal node, the set duration being shorter than default proposal waiting duration of the blockchain network.

In some embodiments of the present disclosure, based on the foregoing solution, the determining unit 904 is configured to determine, in response to the quantity of other blockchain nodes whose differences are greater than or equal to the set threshold is less than the set quantity, the default proposal waiting duration as the proposal waiting duration corresponding to the current proposal node.

In some embodiments of the present disclosure, based on the foregoing solution, the proposal waiting parameter includes a parameter value. The determining unit 904 is configured to perform duration searching based on a mapping relationship between the parameter value and the duration, to obtain duration that has the mapping relationship with the parameter value corresponding to the current proposal node, and determine the duration that has the mapping relationship with the parameter value corresponding to the current proposal node as the proposal waiting duration corresponding to the current proposal node.

In some embodiments of the present disclosure, based on the foregoing solution, the proposal waiting parameter includes a duration parameter. The determining unit 904 is configured to determine a duration parameter corresponding to the current proposal node as the proposal waiting duration corresponding to the current proposal node.

In some embodiments of the present disclosure, based on the foregoing solution, the processing unit 906 is configured to reduce, based on a first set step length in response to the proposal message initiated by the current proposal node is not received within the proposal waiting duration, a value of the proposal waiting parameter corresponding to the current proposal node until the value reaches a minimum value

In some embodiments of the present disclosure, based on the foregoing solution, the processing unit 906 is further configured to adjust, in response to the proposal message initiated by the current proposal node is received within the proposal waiting duration, the proposal waiting parameter corresponding to the current proposal node to maintain or increase the proposal waiting duration corresponding to the current proposal node.

In some embodiments of the present disclosure, based on the foregoing solution, the processing unit 906 is configured to increase, based on a second set step length in response to the proposal message initiated by the current proposal node is received within the proposal waiting duration, a value of the proposal waiting parameter corresponding to the current proposal node until the value reaches a maximum value.

In some embodiments of the present disclosure, based on the foregoing solution, the processing unit 906 is configured to adjust, in response to the proposal message initiated by the current proposal node is received within the proposal waiting duration and consensus with a block targeted by the proposal message is successful, the proposal waiting parameter corresponding to the current proposal node.

In some embodiments of the present disclosure, based on the foregoing solution, the consensus apparatus 900 for the blockchain further includes a generation unit, configured to generate a proposal waiting parameter table before obtaining, based on the recorded proposal waiting parameters corresponding to the blockchain nodes, the proposal waiting parameter corresponding to the current proposal node, the proposal waiting parameter table including default proposal waiting parameters set for the blockchain nodes in the blockchain network.

In some embodiments of the present disclosure, based on the foregoing solution, the processing unit 906 is further configured to synchronize with, from the other blockchain nodes if the blockchain node recovers from an abnormal state to a normal state, proposal waiting parameters corresponding to the blockchain nodes, to update the locally recorded proposal waiting parameters corresponding to the blockchain nodes.

FIG. 10 is a schematic diagram of a structure of a computer system of an electronic device configured to implement an embodiment of the present disclosure.

The electronic device may serve as a blockchain node. A computer system 1000 of the electronic device shown in FIG. 10 is merely an example, and is not to bring any limitation to a function and use range of the embodiments of the present disclosure.

As shown in FIG. 10, the computer system 1000 includes a central processing unit (CPU) 1001, which can perform various suitable actions and processing based on a program stored in a read-only memory (ROM) 1002 or a program loaded from a storage part 1008 into a random access memory (RAM) 1003, for example, perform the method described in the foregoing embodiments. The RAM 1003 further has various programs and data required for system operations stored therein. The CPU 1001, the ROM 1002, and the RAM 1003 are connected to each other by using a bus 1004. An input/output (I/O) interface 1005 is also connected to the bus 1004.

The following components are connected to the I/O interface 1005: an input part 1006 including a keyboard, a mouse, or the like; an output part 1007 including a cathode ray tube (CRT), a liquid crystal display (LCD), a speaker, or the like; a storage part 1008 including a hard disk or the like; and a communication part 1009 including a network interface card such as a local area network (LAN) card, a modem, or the like. The communications part 1009 performs communication processing by using a network such as the Internet. A drive 1010 is also connected to the I/O interface 1005 as required. A removable medium 1011, such as a magnetic disk, an optical disc, a magneto-optical disk, or a semiconductor memory, is mounted on the driver 1010 as required, so that a computer program read from the removable medium is installed into the storage part 1008 as required.

Particularly, according to an embodiment of the present disclosure, the process described above by referring to the flowchart may be implemented as a computer software program. For example, an embodiment of the present disclosure includes a computer program product. The computer program product includes a computer program stored in a computer-readable medium. The computer program includes a computer program used for performing the method shown in the flowchart. In such an embodiment, the computer program may be downloaded and installed from a network and/or installed from the removable medium 1011 by using the communications part 1009. When the computer program is executed by the CPU 1001, various functions defined in the system of the present disclosure are executed.

The computer-readable medium shown in the embodiment of the present disclosure may be a computer-readable signal medium or a computer-readable storage medium or any combination of the above. The computer-readable storage medium may be, for example, but is not limited to, an electric, magnetic, optical, electromagnetic, infrared, or semi-conductive system, apparatus, or component, or any combination of the above. A more specific example of the computer-readable storage medium may include but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any appropriate combination of the above. In the present disclosure, the computer-readable storage medium may be any tangible medium containing or storing a program, and the program may be used by or used in combination with an instruction execution system, an apparatus, or a device. In the present disclosure, the computer-readable signal medium may include a data signal in a baseband or propagated as a part of a carrier wave, the data signal carrying a computer-readable computer program. The data signal propagated in such a way may assume a plurality of forms, including, but not limited to, an electromagnetic signal, an optical signal, or any appropriate combination of the above. The computer-readable signal medium may be further any computer-readable medium in addition to a computer-readable storage medium. The computer-readable medium may send, propagate, or transmit a program that is used by or used in combination with the instruction execution system, apparatus, or device. The computer program included in the computer-readable medium may be transmitted by using any suitable medium, including but not limited to: a wireless medium, a wire, or the like, or any suitable combination thereof.

Flowcharts and a block diagram in the accompanying drawings illustrate example system architectures, functions, and operations that may be implemented by a system, a method, and a computer program product according to various embodiments of the present disclosure. Each box in the flowcharts or the block diagram may represent a module, a program segment, or a part of code. The module, the program segment, or the part of code includes one or more executable instructions used for implementing designated logic functions. In some implementations used as substitutes, functions marked in boxes may alternatively occur in a sequence different from that marked in an accompanying drawing. For example, two boxes shown in succession may actually be performed basically in parallel, and sometimes the two boxes may be performed in a reverse sequence. This is determined by a related function. Each box in the block diagram or the flowcharts and a combination of boxes in the block diagram or the flowcharts may be implemented by using a dedicated hardware-based system configured to perform a specified function or operation, or may be implemented by using a combination of dedicated hardware and a computer program.

Related units described in the embodiments of the present disclosure may be implemented in a software manner, or may be implemented in a hardware manner, and the unit described can also be set in a processor. Names of these units do not constitute a limitation on the units in certain situation.

In another aspect, the present disclosure further provides a computer-readable medium. The computer-readable medium may be included in the electronic device described in the above embodiments, or may exist alone without being assembled into the electronic device. The foregoing computer-readable medium carries one or more computer programs, the one or more computer programs, when being executed by the electronic device, causing the electronic device to implement the method described in the foregoing embodiments.

Although a plurality of modules or units of a device configured to perform actions are described in the foregoing detailed description, such division is not mandatory. Actually, according to the implementations of the present disclosure, features and functions of two or more modules or units described above may be specifically implemented in one module or unit. Conversely, features and functions of one module or unit described above may be further divided into a plurality of modules or units for implementation.

Through descriptions of the foregoing implementations, a person skilled in the art easily understands that the exemplary implementations described herein may be implemented through software, or may be implemented through software located in combination with necessary hardware. Therefore, the technical solution of this embodiment of the present disclosure may be implemented in a form of a software product. The software product may be stored in a non-volatile storage medium which may be a compact disc read-only memory (CD-ROM), a universal serial bus (USB) flash drive, a removable hard disk, or the like; or may be on the network, including several instructions for instructing a computing device (which may be a personal computer, a server, a touch terminal, a network device, or the like) to perform the methods according to the embodiments of the present disclosure.

After considering the specification and practicing the disclosed embodiments, the person skilled in the art may easily conceive of other implementations of the present disclosure. The present disclosure is intended to cover any variations, uses or adaptation of the present disclosure following general principles of the present disclosure, and includes well-known knowledge and conventional technical means in the art and undisclosed in the present disclosure.

The present disclosure is not limited to the precise structures described above and shown in the accompanying drawings, and various modifications and changes can be made without departing from the scope of the present disclosure. The scope of the present disclosure is limited only by the appended claims.

What is claimed is:

1. A consensus method for a blockchain, the method being performed by a blockchain node in a blockchain network, and comprising:
obtaining, based on recorded proposal waiting parameters corresponding to blockchain nodes, a proposal waiting parameter corresponding to a current proposal node in the blockchain nodes;
determining, based on the proposal waiting parameter corresponding to the current proposal node, proposal waiting duration corresponding to the current proposal node; and
adjusting, in response to a proposal message initiated by the current proposal node is not received within the proposal waiting duration at a proposal stage of the current proposal node, the proposal waiting parameter corresponding to the current proposal node to reduce the proposal waiting duration corresponding to the current proposal node.

2. The consensus method for the blockchain according to claim 1, wherein the proposal waiting parameter comprises a parameter value; and the determining, based on the proposal waiting parameter corresponding to the current proposal node, proposal waiting duration corresponding to the current proposal node comprises:
determining a difference between a parameter value corresponding to each of other blockchain nodes and a parameter value corresponding to the current proposal node, the other blockchain nodes being blockchain nodes other than the current proposal node in the blockchain network; and
determining, in response to a quantity of other blockchain nodes whose differences are greater than or equal to a set threshold is greater than or equal to a set quantity, set duration as the proposal waiting duration corresponding to the current proposal node, the set duration being shorter than default proposal waiting duration of the blockchain network.

3. The consensus method for the blockchain according to claim 2, wherein the method further comprises:
determining, in response to the quantity of other blockchain nodes whose differences are greater than or equal to the set threshold is less than the set quantity, the default proposal waiting duration as the proposal waiting duration corresponding to the current proposal node.

4. The consensus method for the blockchain according to claim 1, wherein the proposal waiting parameter comprises a parameter value; and the determining, based on the proposal waiting parameter corresponding to the current proposal node, proposal waiting duration corresponding to the current proposal node comprises:
performing duration searching based on a mapping relationship between the parameter value and duration, to obtain duration that has a mapping relationship with a parameter value corresponding to the current proposal node; and
determining the duration that has the mapping relationship with the parameter value corresponding to the current proposal node as the proposal waiting duration corresponding to the current proposal node.

5. The consensus method for the blockchain according to claim 1, wherein the proposal waiting parameter comprises a duration parameter; and the determining, based on the proposal waiting parameter corresponding to the current proposal node, proposal waiting duration corresponding to the current proposal node comprises:
determining a duration parameter corresponding to the current proposal node as the proposal waiting duration corresponding to the current proposal node.

6. The consensus method for the blockchain according to claim 1, wherein the adjusting, in response to a proposal message initiated by the current proposal node is not received within the proposal waiting duration, the proposal waiting parameter corresponding to the current proposal node comprises:
reducing, based on a first set step length in response to the proposal message initiated by the current proposal node is not received within the proposal waiting duration, a value of the proposal waiting parameter corresponding to the current proposal node until the value reaches a minimum value.

7. The consensus method for the blockchain according to claim 1, wherein the method further comprises:
adjusting, in response to the proposal message initiated by the current proposal node is received within the proposal waiting duration, the proposal waiting parameter corresponding to the current proposal node to maintain or increase the proposal waiting duration corresponding to the current proposal node.

8. The consensus method for the blockchain according to claim 7, wherein the adjusting, in response to the proposal message initiated by the current proposal node is received within the proposal waiting duration, the proposal waiting parameter corresponding to the current proposal node comprises:
increasing, based on a second set step length, in response to the proposal message initiated by the current proposal node is received within the proposal waiting duration, a value of the proposal waiting parameter corresponding to the current proposal node until the value reaches a maximum value.

9. The consensus method for the blockchain according to claim 7, wherein the adjusting, in response to the proposal message initiated by the current proposal node is received within the proposal waiting duration, the proposal waiting parameter corresponding to the current proposal node comprises:
adjusting, in response to the proposal message initiated by the current proposal node is received within the proposal waiting duration and consensus with a block targeted by the proposal message is successful, the proposal waiting parameter corresponding to the current proposal node.

10. The consensus method for the blockchain according to claim 1, wherein before the obtaining, based on recorded proposal waiting parameters corresponding to blockchain nodes, a proposal waiting parameter corresponding to a current proposal node, the method further comprises:
generating a proposal waiting parameter table, the proposal waiting parameter table comprising default proposal waiting parameters set for the blockchain nodes in the blockchain network.

11. The consensus method for a blockchain according to claim 1, wherein the method further comprises:
synchronizing with, from the other blockchain nodes if the blockchain node recovers from an abnormal state to a normal state, proposal waiting parameters corresponding to the blockchain nodes, to update the locally recorded proposal waiting parameters corresponding to the blockchain nodes.

12. A non-transitory computer-readable medium, having a computer program stored herein, the computer program, when being executed by a processor of a blockchain node in a blockchain network, causing the processor to implement:
obtaining, based on recorded proposal waiting parameters corresponding to blockchain nodes, a proposal waiting parameter corresponding to a current proposal node in the blockchain nodes;
determining, based on the proposal waiting parameter corresponding to the current proposal node, proposal waiting duration corresponding to the current proposal node; and
adjusting, in response to a proposal message initiated by the current proposal node is not received within the proposal waiting duration at a proposal stage of the current proposal node, the proposal waiting parameter corresponding to the current proposal node to reduce the proposal waiting duration corresponding to the current proposal node.

13. The storage medium according to claim 12, wherein the proposal waiting parameter comprises a parameter value; and the determining, based on the proposal waiting parameter corresponding to the current proposal node, proposal waiting duration corresponding to the current proposal node comprises:
determining a difference between a parameter value corresponding to each of other blockchain nodes and a parameter value corresponding to the current proposal node, the other blockchain nodes being blockchain nodes other than the current proposal node in the blockchain network; and
determining, in response to a quantity of other blockchain nodes whose differences are greater than or equal to a set threshold is greater than or equal to a set quantity, set duration as the proposal waiting duration corresponding to the current proposal node, the set duration being shorter than default proposal waiting duration of the blockchain network.

14. The storage medium according to claim 13, wherein the computer program further causes the processor to perform:
determining, in response to the quantity of other blockchain nodes whose differences are greater than or equal to the set threshold is less than the set quantity, the default proposal waiting duration as the proposal waiting duration corresponding to the current proposal node.

15. The storage medium according to claim 12, wherein the proposal waiting parameter comprises a parameter value; and the determining, based on the proposal waiting parameter corresponding to the current proposal node, proposal waiting duration corresponding to the current proposal node comprises:
performing duration searching based on a mapping relationship between the parameter value and duration, to obtain duration that has a mapping relationship with a parameter value corresponding to the current proposal node; and
determining the duration that has the mapping relationship with the parameter value corresponding to the current proposal node as the proposal waiting duration corresponding to the current proposal node.

16. The storage medium according to claim 12, wherein the proposal waiting parameter comprises a duration parameter; and the determining, based on the proposal waiting parameter corresponding to the current proposal node, proposal waiting duration corresponding to the current proposal node comprises:
determining a duration parameter corresponding to the current proposal node as the proposal waiting duration corresponding to the current proposal node.

17. The storage medium according to claim 12, wherein the adjusting, in response to a proposal message initiated by the current proposal node is not received within the proposal waiting duration, the proposal waiting parameter corresponding to the current proposal node comprises:
reducing, based on a first set step length in response to the proposal message initiated by the current proposal node is not received within the proposal waiting duration, a value of the proposal waiting parameter corresponding to the current proposal node until the value reaches a minimum value.

18. The storage medium according to claim 12, wherein the computer program further causes the processor to perform:
adjusting, in response to the proposal message initiated by the current proposal node is received within the proposal waiting duration, the proposal waiting parameter corresponding to the current proposal node to maintain or increase the proposal waiting duration corresponding to the current proposal node.

19. The storage medium according to claim 18, wherein the adjusting, in response to the proposal message initiated by the current proposal node is received within the proposal waiting duration, the proposal waiting parameter corresponding to the current proposal node comprises:
increasing, based on a second set step length, in response to the proposal message initiated by the current proposal node is received within the proposal waiting duration, a value of the proposal waiting parameter corresponding to the current proposal node until the value reaches a maximum value.

20. An electronic device, comprising:
one or more processors; and
a memory, configured to store one or more computer programs, the one or more computer programs, when being executed by the one or more processors, enabling the electronic device to implement:
obtaining, based on recorded proposal waiting parameters corresponding to blockchain nodes, a proposal waiting parameter corresponding to a current proposal node in the blockchain nodes;
determining, based on the proposal waiting parameter corresponding to the current proposal node, proposal waiting duration corresponding to the current proposal node; and
adjusting, in response to a proposal message initiated by the current proposal node is not received within the proposal waiting duration at a proposal stage of the current proposal node, the proposal waiting parameter corresponding to the current proposal node to reduce the proposal waiting duration corresponding to the current proposal node.
